(19) United States
(12) Patent Application Publication
(10) Pub. No.: US 2005/0050765 A1
(43) Pub. Date: Mar. 10, 2005

(54) Apparatus for suctioning external air of clothes dryer

(75) Inventors: Young-Hwan Park, Seoul (KR); Kyung-Seop Hong, Incheon (KR); In-Cheol Jeong, Goyang (KR); Dae-Yun Park, Gwangmyeong (KR); Soo-Young Oh, Seoul (KR); Si-Moon Jeon, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 10/912,081

(22) Filed: Aug. 6, 2004

(30) Foreign Application Priority Data
Aug. 13, 2003 (KR) 56017/2003

(51) Int. Cl. F26B 11/02

(52) U.S. Cl. 34/603

(57) ABSTRACT

An apparatus for suctioning external air of a clothes dryer, comprises a housing provided at one side with a suction port for introducing external air; a fan installed at the housing and generating a suction force for sucking external air while being rotated; a driving motor driving the fan; a guide duct guiding the external air introduced from the suction port to a condenser; and a grille installed at a predetermined gap from one side face of the housing where the suction port is to be installed so that a channel can be formed between the grille and the one side face and comprised of a plurality of grille plates extending in a direction lengthwise of the grille, one widthwise ends of the grille plates being bent toward the suction port. Accordingly, the apparatus has advantages such as a decrease in flow resistance, an improvement of a condensing effect and a decrease of vibration and noise by setting the flow amount and flow velocity of a cooling air to be suctioned in the best condition.

### BACKGROUND OF THE INVENTION

1. Field of the Invention

The present invention relates to a clothes dryer, and more particularly to, an apparatus for suctioning external air of a clothes dryer which is capable of smoothly introducing a cooling air for condensing a high temperature and high humidity air discharged from a drum.

2. Description of the Background Art

A clothes dryer is an apparatus which dries wet laundry by a series of processes, including absorbing moisture of an object to be dried by feeding a hot and dry air into a rotating drum and condensing high temperature and high humidity air generated in the above process at the exterior of the drum and discharging it.

As shown in FIG. 1, a conventional clothes dryer includes: a case 101 forming the outward appearance; a drum 102 rotatably stored in the case 101 and for holding an object to be dried; a circulating duct 103 connected to the drum 102 and for supplying air toward the drum 102; a heater 104 heating the air fed to the drum 102 through the circulating duct 103; a condenser 105 installed in the middle of the circulating duct 104 and for removing the moisture contained in the air supplied to the drum 102; a cooling fan 122 for introducing external air in order to condense a high temperature and high humidity air in the condenser 105; a motor (not shown) for rotating the drum 102 and the cooling fan 122 respectively; a suction duct 112 for guiding the external air to the cooling fan 122 from an air inlet 115 opened to the front side of the case 101; and a grille comprised of a plurality of grille plates 132 extending in a horizontal direction in order to covered-open the air inlet 115 and permit an air flow into the air inlet 115.

In the conventional clothes dryer constructed as above, when an object to be dried is put into the drum 102 and the drum 102 and the heater 104 are operated, a high temperature air is introduced into the drum 102 and a high temperature and high humidity air having absorbed the moisture of the object to be dried while passing through the object to be dried is introduced into the condenser 105.

The air introduced into the condenser 105 is changed into a low temperature and low humidity air by a heat exchange with an external air sucked by the operation of the cooling fan 122, then reheated by the heater 104 and then reintroduced into the drum 102. At this time, the moisture contained in the air is cooled and changed into water, and then discharged out of the clothes dryer. And, as the above process is repeated, the drying operation of the object to be dried held in the drum 102 is carried out.

In the above-said conventional clothes dryer, although it is most suitable that the air inlet 115 is located in the substantially same position as the horizontal and vertical positions of the suction duct 112, there is no choice other than to locate the air inlet 115 downward from the vertical position of the suction duct 112 from an aspect of the arrangement of other components of the clothes dryer, the design of a main body or the like.

However, in the conventional clothes dryer, since the grille 130 and the a channel formed between the grille 130 and the suction duct 112 is designed in such a shape that does not consider the flow amount and flow velocity of external air, the size of a flow resistance generated while the introduced air passes through the grille 130 and the suction duct 112 is increased. Subsequently, there is a problem that the flow amount of the external air is decreased to degrade the condensing effect of the condenser 105 and another problem that the reliability of the clothes dryer is degraded because the flow resistance of the air leads to the generation of vibration and noise.

### SUMMARY OF THE INVENTION

Therefore, an object of the present invention is to provide an apparatus for suctioning external air of a clothes dryer which minimizes the flow resistance of external air to be suctioned and optimizes the flow amount and flow velocity by optimally designing grille plate of a grille covered-opening an air inlet for introducing external air in their shape and arrangement position.

To achieve these and other advantages and in accordance with the purpose of the present invention, as embodied and broadly described herein, there is provided an apparatus for suctioning external air of a clothes dryer, comprising: a housing provided at one side with a suction port for introducing external air; a fan installed at the housing and generating a suction force for sucking external air while being rotated; a driving motor driving the fan; a guide duct guiding the external air introduced from the suction port to a condenser; and a grille installed at a predetermined gap from one side face of the housing where the suction port is to be installed so that a channel can be formed between the grille and the one side face and comprised of a plurality of grille plates extending in a direction lengthwise of the grille, one widthwise ends of the grille plates being bent toward the suction port.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view showing a conventional clothes dryer;

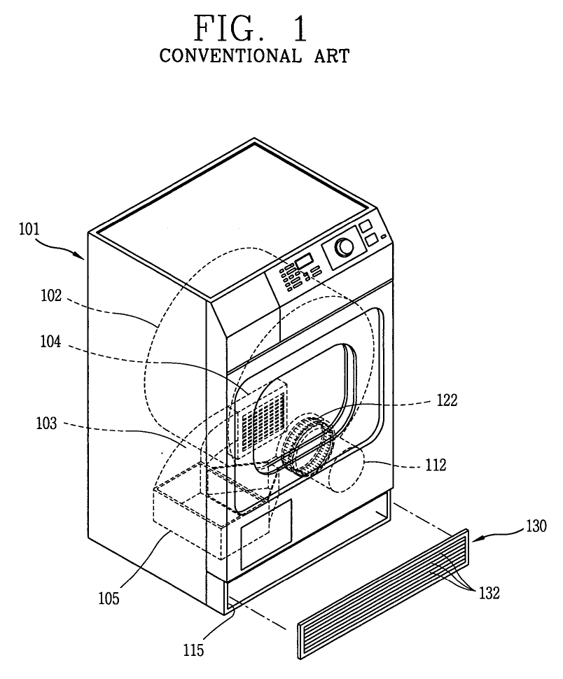

FIG. 2 is a perspective view showing a clothes dryer according to the present invention;

FIG. 3 is a perspective view showing an apparatus for suctioning external air of a clothes dryer according to the present invention;

FIG. 4 is a perspective view showing a grille provided at the apparatus for suctioning external air of the clothes dryer according to the present invention;

FIG. 5 is a sectional view of line V-V of FIG. 4; and

FIGS. 6, 7 and 8 are perspective views of the apparatus for suctioning external air of the clothes dryer according to the present invention in which the width of a channel formed between the grille and a housing is differently set.

### DETAILED DESCRIPTION OF THE PREFERRED EMBODIMENTS

Hereinafter, a preferred embodiment of the present invention will be described in detail with reference to the accompanying drawings.

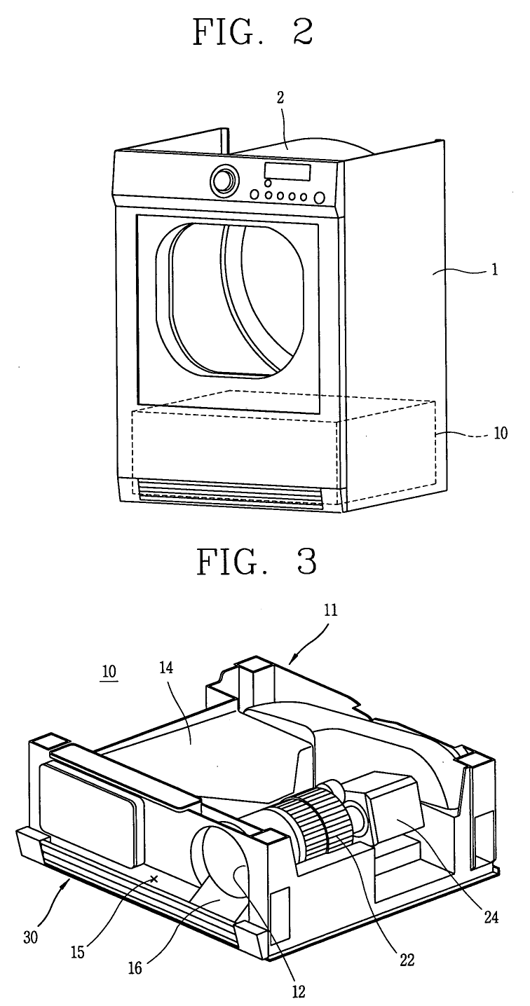

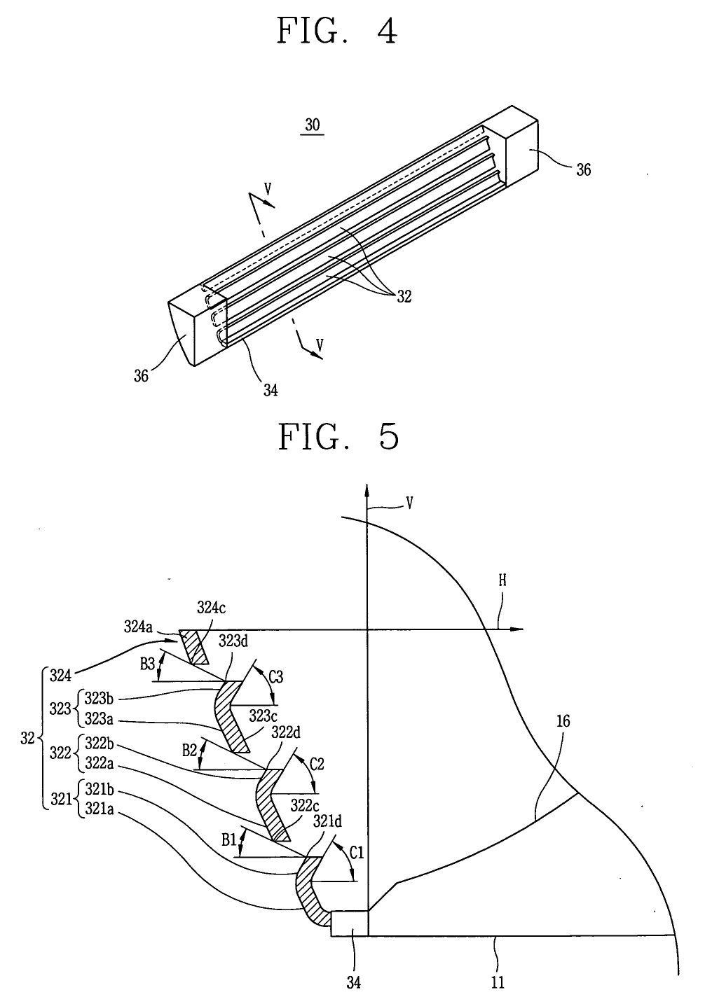

As shown in FIGS. 2 and 3, an apparatus 10 for suctioning external air of a clothes dryer comprises: a housing 11 arranged in a lower side of a main body 1 of the clothes dryer having a drum 21 installed therein and provided at one side with a suction port 12 for introducing external air; a fan 22 installed at the housing 11 and generating a suction force for sucking external air while being rotated; a driving motor 24 driving the fan 22; a guide duct 14 installed at the housing 11 and guiding the external air introduced from the suction port 12 to a condenser (not shown); and a grille 30 installed at a predetermined gap from one side face of the housing 11 where the suction port 12 is to be installed so that a channel 15 can be formed between the grille 30 and the one side face and covered-opening the suction port 12 to be able to introduce external air.

Additionally, a guide unit 16 having a curved surface of a predetermined angle is formed between the suction port 12 and the grille 30 so as to smoothly introduce the air introduced from the grille 30 toward the suction port 12.

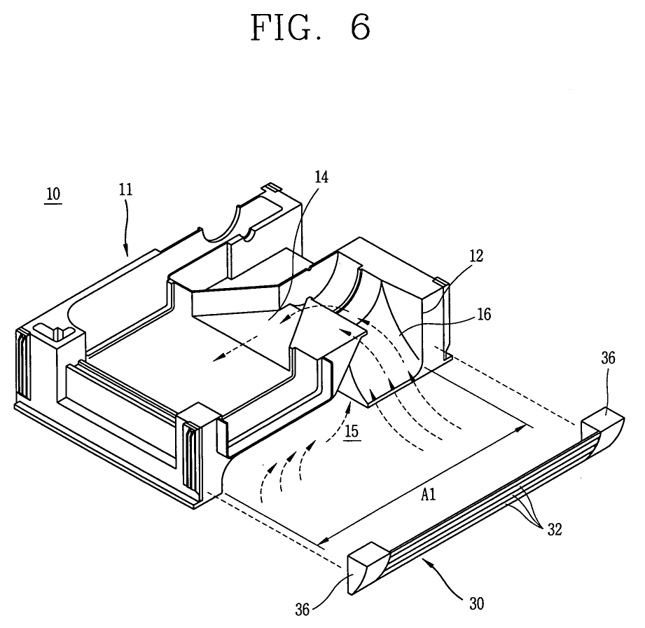

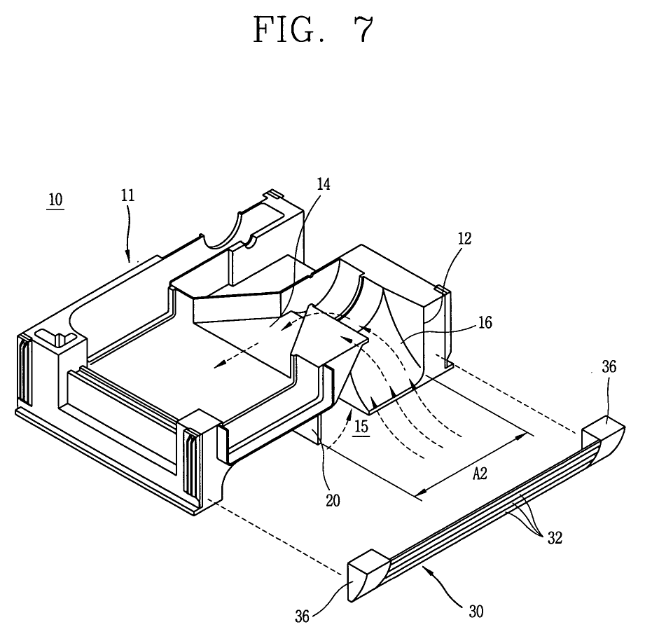

As shown in FIGS. 4 and 5, the grille 30 includes a pair of stationary members 36 mounted on the housing 11 and a plurality of grille plates 32 each installed between the stationary members 36.

Here, the plurality of grille plates 32 is sequentially arranged with a slope from the vertical axis V of the suction port 12. That is, the plurality of grille plates 32 is installed in such a direction in which they become more distant from the suction port 12 as they proceed upward.

Specifically, the plurality of grille plate 32 has a first grille plate 321, a second grille plate 322, a third grille plate 323 and a fourth grille plate 324 defined in an upward order from the vertical axis V. The number of grille plates 32 of this type is not restricted thereto, but may be larger or smaller than that.

The plurality of grille plates 321, 322, 323 and 324 is bent so that both widthwise ends thereof face the inlet port 12. Accordingly, the plurality of grille plates 321, 322, 323 and 324 includes first portions 321a, 322a, 323a and 324a arranged below from a bent line and formed with a slope from the vertical axis V; and second portions 321b, 322b and 323b arranged above from the bent line and formed with a slope from the vertical axis V.

Although the respective surfaces of the first portions 321a, 322a, 323a and 324a and second portions 321b, 322b and 323b facing the suction port may be formed in a flat shape, they also may be formed in a curved shape having a predetermined curvature in consideration of the flow resistance of air.

Preferably, the second portions 321b, 322b and 323b have a width about one thirds of the overall width of the grille plates 32, i.e., a width about one-halves of the width of the first portions 321a, 322a, 323a and 324a.

Preferably, to reduce the flow resistance of the air introduced between the plurality of grille plates 321, 322, 323 and 324, the ends of the first portions 322a, 323a and 324 and the ends of the second portions 321b, 322b and 323b, i.e., both opposite ends of the grille plates 321, 322, 323 and 324, are formed as surfaces respectively parallel to the horizontal axis H of the grille 30. Further, it is preferred that the gap between the first grille plate 321 located at the lowermost side of the grille plates 321, 322, 323 and 324 and the housing 11 is sealed so as to avoid an air flow. Consequently, a sealing member 34 is installed between the first grille plate 321 and the housing 11.

In the above-constructed apparatus according to the present invention, in order to improve the inflow of air introduced to the suction port 12 through the grille 30, an experiment with parameters like the shape and arrangement position of the grille plates 321, 322, 323 and 324 for minimizing the flow resistance of air is carried out. As a result, the optimum design values as shown in the following Table 1 can be obtained.

In Table 1, B1 is an angle formed between a straight line, which passes an end point 321d formed in a direction getting distant from the suction port 12 on the widthwise end of the second portion 321b of the first grille plate 321 and an end point 322c formed in a direction getting distant from the suction port 12 on the widthwise end of the first portion 322a of the second grille plate 322, and a line parallel to the horizontal axis H, B2 is an angle formed between a straight line, which passes an end point 322d formed in a direction getting distant from the suction port 12 on the widthwise end of the second portion 322b of the first grille plate 322 and an end point 323c formed in a direction getting distant from the suction port 12 on the widthwise end of the first portion 323a of the third grille plate 323, and a line parallel to the horizontal axis H, and B3 is an angle formed between a straight line, which passes an end point 323d formed in a direction getting distant from the suction port 12 on the widthwise end of the second portion 323b of the first grille plate 323 and an end point 324c formed in a direction getting distant from the suction port 12 on the widthwise end of the first portion 324a of the third grille plate 324, and a line parallel to the horizontal axis H.

C1, C2 and C3 are angles at which the second portions 321b, 322b and 323b of the plurality of grille plates 321, 322, 323 and 324 are inclined relative to the horizontal axis H of the grille 30. That is, they are angles formed between a straight line, which passes the respective bent lines of the grille plates 321, 322, 323 and 324 and the end points in a direction adjacent to the suction port 12 formed on the widthwise ends of the second portions 321b, 322b and 323b, and a line parallel to the horizontal axis H.

TABLE 1

| Grille | B1, B2 and B3 | C1, C2 and C3 |
|---|---|---|
| Type I | less than 30° | same |
| Type II | from 30° to 50° | different |

As shown in Table 1, as a result of an experiment using design factors like the shape and arrangement position of the grill plate 32 in order to reduce the flow resistance of air introduced through the grille 30, it is found that the best result in reducing the flow resistance can be obtained by designing the grille 30 of the type I so that B1, B2 and B3 are less than 30° and C1, C2 and C3 have the same degree or designing the grille 30 of type II so that B1, B2 and B3 range from 30° to 50° and C1, C2 and C3 have different degree.

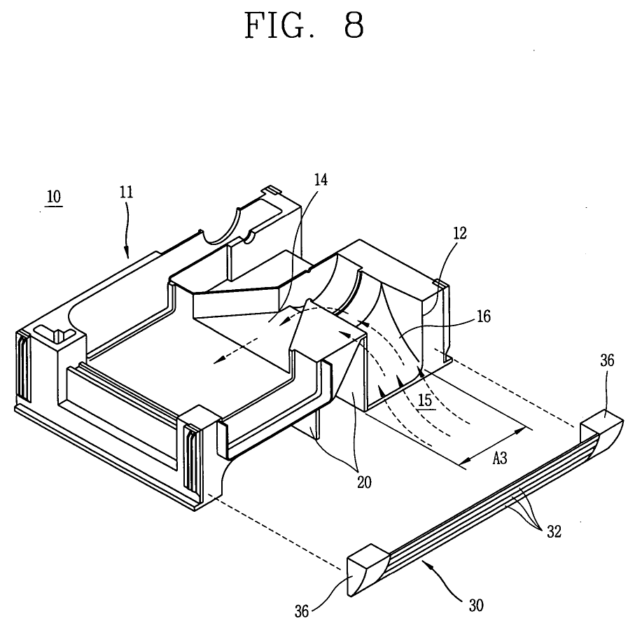

Hereinafter, with reference to FIGS. 6 to 8 and Table 2, the optimum design of a channel 15 formed between the grille 30 and one surface of the housing 11 at which the suction port 12 is formed will be described.

FIG. 6 is a perspective view showing the apparatus 10 for suctioning external air having a channel structure of type I in which the length A1 of the channel 15 is substantially the same as the overall width of the grille 30. FIG. 7 is a perspective view showing the apparatus 10 for suctioning external air having a channel structure of type II in which the length A2 of the channel 15 is about a half the length A2 of the channel 15 of the channel structure of type I. FIG. 8 is a perspective view showing the apparatus 10 for suctioning external air having a channel structure of type III in which the length A3 of the channel 15 is restricted to about the width of the suction port 12.

In order to increase the inflow of air passing through the grille 30 and the suction port 12, it is advantageous for the length A1 of the channel 15 to be substantially the same as the overall width of the grille 30 as shown in the channel structure of type I. However, in case of the apparatus 10 having the channel structure of type I, the supporting strength of the grille 30 supported on the housing 11 is weakened. To overcome this problem, as shown in the apparatus 10 having the channel structure of type II and type III, a supporting element 20 is installed in the middle of the channel 15 to increase the supporting strength of the grille 30.

TABLE 2

| | |
|---|---|
| Channel | Grille Structure |

| Structure | Type I | Type II |
|---|---|---|
| Type I | best | best |
| Type II | decrease in air quantity | good |
| Type III | decrease in air quantity | good |

As shown in Table 2, in the channel structure of type I, the best result in reducing the flow resistance can be obtained under the design condition of the grille 30 where B1, B2 and B3 are less than 30° and C1, C2 and C3 have the same degree or under the design condition of the grille 30 where B1, B2 and B3 range from 30° to 50° and C1, C2 and C3 have different degrees. In contrast, in case of the channel structure of type II and type III, under the design condition of the grille 30 where B1, B2 and B3 are less than 30° and C1, C2 and C3 have the same degree, the flow amount of air decreases by about 4.5% as compared to the apparatus 10 of type I. However, in case of the apparatus 10 of type II and type III, under the design condition of the grille 30 where C1, C2 and C3 have the same degree or under the design condition of the grille 30 where B1, B2 and B3 range from 30° to 50° and C1, C2 and C3 have different degrees, the flow amount of air decreases by no more than about 2.4% as compared to the apparatus 10 of type I.

Subsequently, in case of the apparatus 10 of type II and type III which has the supporting element 20 installed at the channel 15 in order to improve the supporting strength of the grille 30, it is preferred that the grille 30 of type II is designed in such a manner that C1, C2 and C3 have the same degree or in such a manner that B1, B2 and B3 range from 30° to 50° and C1, C2 and C3 have different degrees.

As described above, the apparatus 10 for suctioning external air of the clothes dryer according to the present invention has an advantage that the flow resistance of air to be suctioned is minimized and the flow amount and flow velocity of air are optimized by mounting a grille with the optimum shape and arrangement position of grille plates set.

Furthermore, the apparatus 10 for suctioning external air of the clothes dryer according to the present invention has another advantage that a decrease in the quantity of air to be suctioned is minimized even if the length of the channel formed between the grille and the housing is decreased in order to increase the supporting length of the grille.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. An apparatus for suctioning external air of a clothes dryer, comprising:
a housing provided at one side with a suction port for introducing external air;
a fan installed at the housing and generating a suction force for sucking external air while being rotated;
a driving motor driving the fan;
a guide duct guiding the external air introduced from the suction port to a condenser; and
a grille installed at a predetermined gap from one side face of the housing where the suction port is to be installed so that a channel can be formed between the grille and the one side face and comprised of a plurality of grille plates extending in a direction lengthwise of the grille,
one widthwise ends of the grille plates being bent toward the suction port.

2. The apparatus of claim 1, wherein the plurality of grille plates are sequentially arranged with a slope from the vertical axis of the grille.

3. The apparatus of claim 2, wherein each of the grille plates is divided into a first portion and a second portion by a bent line for bending the grille plates, the first portion and the second portion being formed with a slope so that the widthwise ends thereof face the suction port.

4. The apparatus of claim 3, wherein each surface of the first and second portions, facing the suction port are formed in a curved shape.

5. The apparatus of claim 3, wherein the second portion has a width about one halves of the width of the second portion.

6. The apparatus of claim 3, wherein both opposite ends of the respective grille plates are formed as a flat surface parallel to the horizontal axis of the grille.

7. The apparatus of claim 3, wherein a gap between the grille plate on the outermost periphery of the plurality of grille plates and the housing is sealed.

8. The apparatus of claim 3, wherein a length of the channel in a direction lengthwise of the grille is substantially the same as a length of the grille.

9. The apparatus of claim 8, wherein an angle formed between a line drawn from the widthwise end of the first portion of one of the plurality of grill plates to the widthwise end of the second portion of another grill plate adjacent to the grille plate and a line parallel to the horizontal axis of the grille is less than 30°; and
angles at which each second portion of the plurality of grille plates is inclined relative to the horizontal axis of the grille are the same to each other.

10. The apparatus of claim 8, wherein an angle formed between a line drawn from the widthwise end of the first portion of one of the plurality of grill plates to the widthwise end of the second portion of another grill plate adjacent to the grille plate and a line parallel to the horizontal axis of the grille is in a range of 30° to 50°; and
angles at which each second portion of the plurality of grille plates is inclined relative to the horizontal axis of the grille are different from each other.

11. The apparatus of claim 3, wherein a length of the channel in a direction lengthwise of the grille is smaller than a length of the grille.

12. The apparatus of claim 11, wherein an angle formed between a line drawn from the widthwise end of the first portion of one of the plurality of grill plates to the widthwise end of the second portion of another grill plate adjacent to the grille plate and a line parallel to the horizontal axis of the grille is in a range of 30° to 50°; and
angles at which the second portions of the plurality of grille plates are inclined relative to the horizontal axis of the grille are different from each other.

13. The apparatus of claim 1, wherein a guide unit having a curvature of a predetermined angle is formed between the suction port and the grille so as to smoothly introduce air introduced from the grille toward the suction port.
